(19) United States
(12) Patent Application Publication
(10) Pub. No.: US 2003/0217355 A1
(43) Pub. Date: Nov. 20, 2003

(54) System and method of implementing a virtual data modification breakpoint register

(75) Inventors: Mark Elliott Hack, Cedar Park, TX (US); James A. Lindeman, Austin, TX (US)

Correspondence Address: Mr. Volel Emile, P.O. Box 202170, Austin, TX, 78720-2170, US

(73) Assignee: International Business Machines Corporation, Armonk, NY (US)

(21) Appl. No.: 10/150,114

(22) Filed: May 16, 2002

(51) Int. Cl. H02H 3/05; G06F 9/44

(52) U.S. Cl. 717/129; 714/35; 714/38

(57) ABSTRACT

A system and method of implementing a virtual data modification breakpoint register (V-DMBR) are provided. First, a compiler is modified to insert instructions to have a value of a monitored data copied into another memory address. The compiler is further modified to insert into the program commands to compare the two values upon each function call entry and exit and to go to a software handler if a difference ensues. Then, when a piece of data is to be monitored for corruptions or modifications while a program is executing, the address of the data is entered into the program and the program is re-compiled. Alternatively, a debugger may be used to activate the invention. In that case, the data to be monitored is passed to an executing program using the debugger. But as before, the executing program must have been compiled using the modified compiler.

### BACKGROUND OF THE INVENTION

1. Technical Field

The present invention relates generally to a method, and system for isolating memory corruptions or modifications to items stored in memory. More specifically, the present invention relates to a method, system and apparatus for implementing a virtual data modification breakpoint register (V-DMBR) for isolating memory corruptions or modifications to items stored in memory.

2. Description of Related Art

Most modern processors or CPUs are designed with data access breakpoint registers (DABRs). A DABR is used to generate trace faults on certain data accesses. Specifically, a DABR causes a trace event to occur when data is written into a protected address. A protected address is an address that is stored into the DABR. When data is written into the protected address, the processor generates a trace fault and makes a call to a trace fault handling procedure. This procedure may, in turn, call a debugging software to display and analyze the state of the program. This analysis may be used to locate memory corruptions or to locate modifications made to data stored in memory.

A DABR may be armed or disarmed. If a DABR is armed, the above-described action takes place whenever data is written into the protected address. If a DABR is disarmed, no action occurs and execution continues as normal.

Obviously, generations of trace faults triggered by a DABR can only occur on computer systems with a DABR-equipped CPU. In addition, only data written into the protected address by the DABR-equipped CPU may generate trace faults; that is, data written into the protected address by input/output devices through direct memory accesses (DMAs), for instance, will not generate trace faults. Thus, it would be desirable to generate trace faults whenever data is written into a protected address regardless of whether or not the data is written by a CPU-equipped DABR.

Another tool that is used to identify data corruptions is a call-stack verifier. A call-stack verifier is a feature that may be implemented at compile time in most C compilers supplied by Microsoft®. A call-stack, as will be explained later, contains the names of all running functions in a hierarchical fashion. When a program is executing and calls a function, the call-stack verifier stores the name of the function into a call-stack buffer. As the function finishes to execute, the call-stack verifier compares the content of the call-stack buffer to the actual call-stack. Any discrepancy is an indication that an error may have occurred.

Thus, the call-stack verifier is used to detect corruptions in data representing a call-stack. This data is stored in a small area of a memory system. Consequently, a call-stack verifier only detects data corruptions in a small area of a memory system and not in the entire memory system. It would certainly be desirable to be able to detect data corruptions anywhere in a memory system rather than in a small area where a call-stack may be stored.

A further tool that is used to identify data corruptions is a trace function. A trace function is available in most software debugging tools. A trace function allows a software developer to mark variables for debugging purposes. When a variable is marked for debugging purposes, the debugging software monitors each instruction being executed to determine whether it is updating the variable. When the variable is updated, the trace function enters in a file the instruction that updates the variable for future analysis by the software developer. Thus, the trace function allows for data corruption detection at the instruction level.

However to function as described above, a hardware interface to the CPU and to the memory that can be driven by a software debugging tool is needed. In addition, the software debugging tool has to be running on a different computer system. Alternatively, a software layer running on the same computer system on which the program is executing that can invoke and drive the software debugging tool is needed. Neither the hardware interface nor the software layer is a readily and cheaply available component.

Thus, what is needed is a system and method of detecting data corruptions or data modifications anywhere in a memory system. The system and method must do so without any additional component and regardless of whether or not the corrupted data is written into the memory system by a CPU-equipped DABR.

### SUMMARY OF THE INVENTION

The present invention provides a system and method of implementing a virtual data modification breakpoint register (V-DMBR). Basically, the invention enables a compiler to insert instructions into a program to have a stored data copied into another location and to have the values of the data and its copy compared at certain times to pinpoint data errors or modifications. The alternative, besides having a DABR, would be for a programmer to write code for checking the value of the data each time it is read or written into memory and to compare the value before and after it is written in memory. The invention relieves the programmer from doing so and at a lower overhead. In addition, the invention may be used in I/O driven DMA environments or where data is being modified by multiple processors.

The invention is implemented by first modifying a compiler to insert into a program instructions to have a value of a monitored data copied into another memory address. The compiler is further modified to insert into the program commands to compare the value of the monitored data and the value of the copy of the monitored data upon each function call entry and exit and to go to a software handler if a difference ensues. Then, when a piece of data is to be monitored for corruptions or modifications, the address of the data is entered into the program and the program is compiled using the modified compiler. This is done for two reasons: (1) to activate the invention and (2) to supply the address of the data to be monitored. During execution of the program, when there is a difference between the values of the monitored data and its copy, the software handler is called. The software handler generates a call-stack dump to allow errors or modifications to be isolated.

An alternative embodiment is to use a debugger to activate the invention. In that case, the address of the data is passed to an executing program using the debugger. But as before, the executing program must have first been compiled with the modified compiler.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a server apparatus according to the present invention.

FIG. 2 is an exemplary block diagram of a client apparatus according to the present invention.

FIG. 3 is a flow chart of a process that a compiler may go through when implementing the invention.

FIG. 4 is an actual piece of code that may be used to implement the modifications of the compiler.

FIG. 5 is a flow chart of a process that may be used in implementing Software Handler.

FIGS. 6A-6E illustrate a function call-stack.

### DETAILED DESCRIPTION OF THE PREFERRED EMBODIMENT

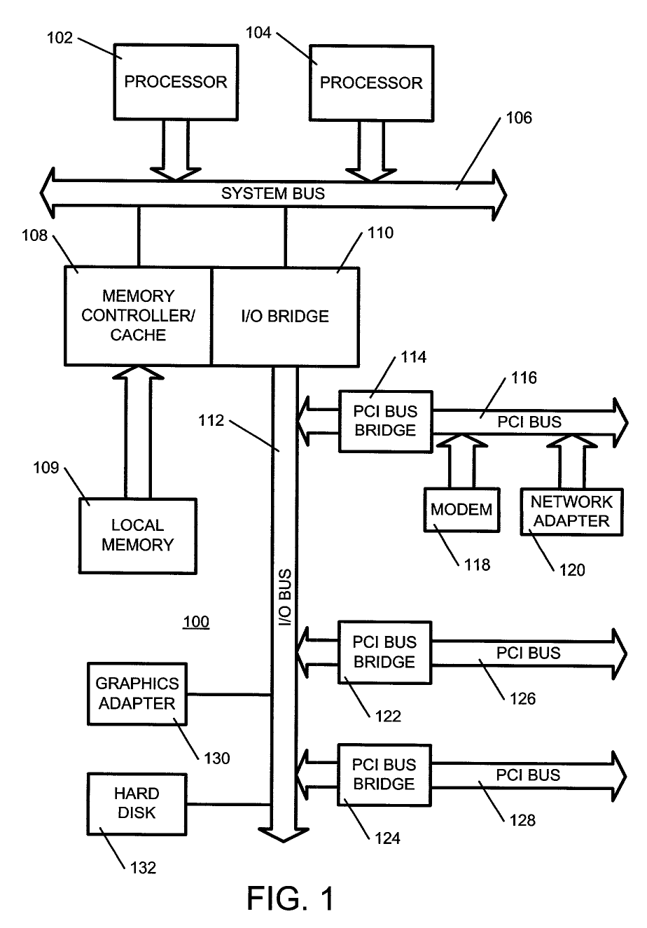

With reference now to the figures, FIG. 1 is a block diagram of a data processing system that may be implemented as a server. Data processing system 100 may be a symmetric multiprocessor (SMP) system including a plurality of processors 102 and 104 connected to system bus 106. Alternatively, a single processor system may be employed. Also connected to system bus 106 is memory controller/cache 108, which provides an interface to local memory 109. I/O bus bridge 110 is connected to system bus 106 and provides an interface to I/O bus 112. Memory controller/cache 108 and I/O bus bridge 110 may be integrated as depicted. Peripheral component interconnect (PCI) bus bridge 114 connected to I/O bus 112 provides an interface to PCI local bus 116. A number of modems may be connected to PCI local bus 216. Typical PCI bus implementations will support four PCI expansion slots or add-in connectors. Communications links to other computers may be provided through modem 118 and network adapter 120 connected to PCI local bus 116 through add-in boards. Additional PCI bus bridges 122 and 124 provide interfaces for additional PCI local buses 126 and 128, from which additional modems or network adapters may be supported. In this manner, data processing system 100 allows connections to multiple network computers. A memory-mapped graphics adapter 130 and hard disk 132 may also be connected to I/O bus 112 as depicted, either directly or indirectly.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 1 may be, for example, an IBM e-Server pSeries system, a product of International Business Machines Corporation in Armonk, N. Y., running the Advanced Interactive Executive (AIX) operating system or LINUX operating system.

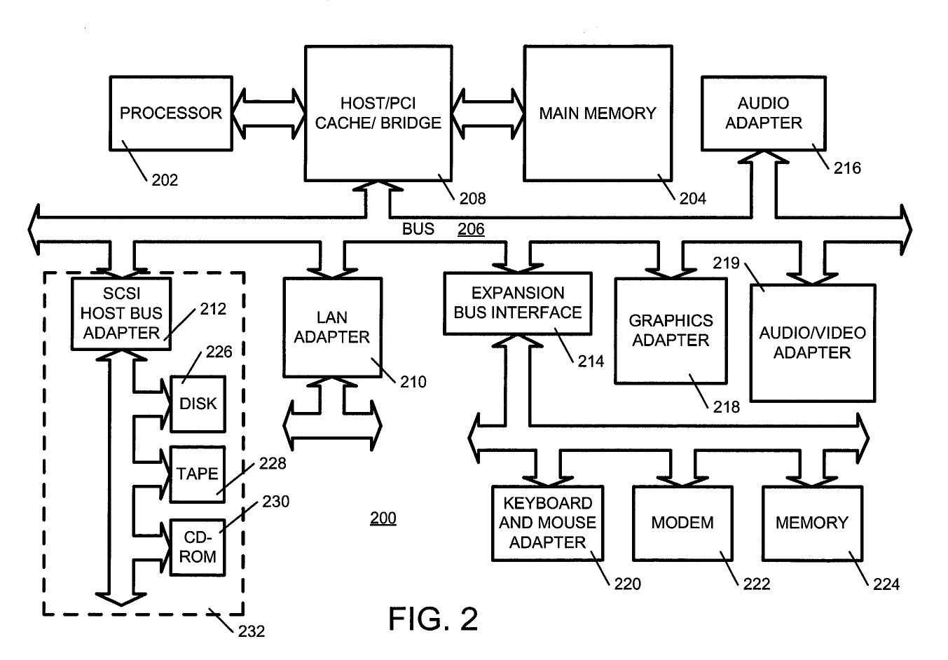

With reference now to FIG. 2, a block diagram illustrating a data processing system is depicted in which the present invention may be implemented. Data processing system 200 is an example of a client computer. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. Small computer system interface (SCSI) host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system, such as Windows 2000, which is available from Microsoft Corporation. An object oriented programming system such as Java may run in conjunction with the operating system and provide calls to the operating system from Java programs or applications executing on data processing system 200. “Java” is a trademark of Sun Microsystems, Inc. Instructions for the operating system, the object-oriented operating system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash ROM (or equivalent nonvolatile memory) or optical disk drives and the like, may be used in addition to or in place of the hardware depicted in FIG. 2. Also, the processes of the present invention may be applied to a multiprocessor data processing system.

As another example, data processing system 200 may be a stand-alone system configured to be bootable without relying on some type of network communication interface, whether or not data processing system 200 comprises some type of network communication interface. As a further example, data processing system 200 may be a Personal Digital Assistant (PDA) device, which is configured with ROM and/or flash ROM in order to provide non-volatile memory for storing operating system files and/or user-generated data.

The depicted example in FIG. 2 and above-described examples are not meant to imply architectural limitations. For example, data processing system 200 may also be a notebook computer or hand held computer in addition to taking the form of a PDA. Data processing system 200 also may be a kiosk or a Web appliance.

The present invention is a virtual DABR or rather a virtual data modification breakpoint register (V-DMBR) that may be used to isolate data corruptions or modifications. The present invention may reside on any data storage medium (i.e., floppy disk, compact disk, hard disk, ROM, RAM, etc.) used by a computer system.

The invention assumes that corrupted variables or addresses of corrupted variables are known. If so, a software developer or programmer may specify which address or addresses are to be protected and where in a program the protection is to start. For example, suppose variable V-DMBR is the variable whose data is being corrupted, then the software developer may insert an event-tracing-triggering command at a location in the program where the variable V-DMBR is to begin being monitored. Note that it is well known that an offending variable or its address may easily be determined by first running a program through a debugger.

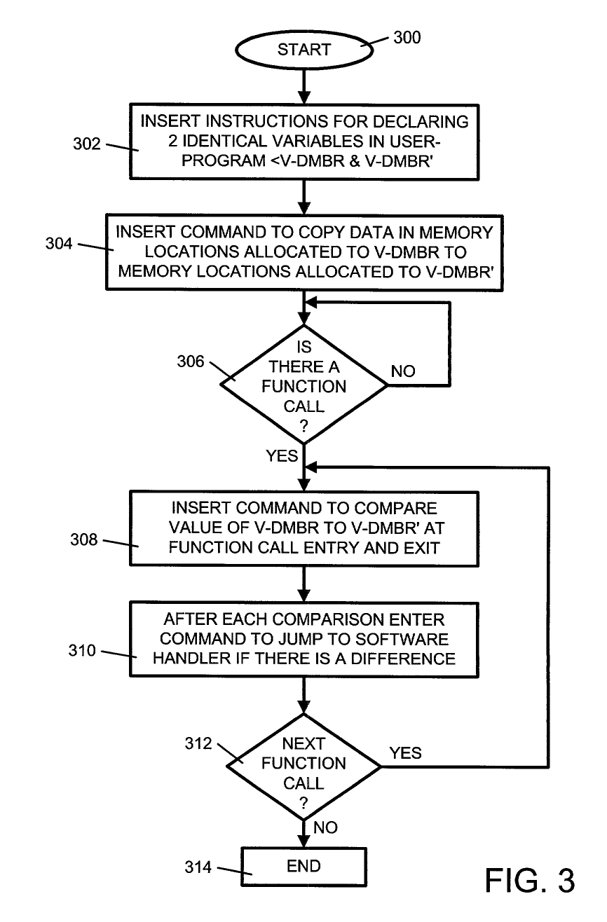

Once the event-tracing-triggering command is entered into the program, the programmer may then compile and load the program on a target computer system (i.e., the computer system on which data corruptions are occurring). However, before the program is compiled, the compiler has to have been modified to recognize the event-tracing-triggering command. In our example, the command SET V-DMBR to “data to be monitored” is used as the event-tracing-triggering command. Thus, the compiler has to be modified to behave as outlined in FIG. 3 when it encounters the event-tracing-triggering command.

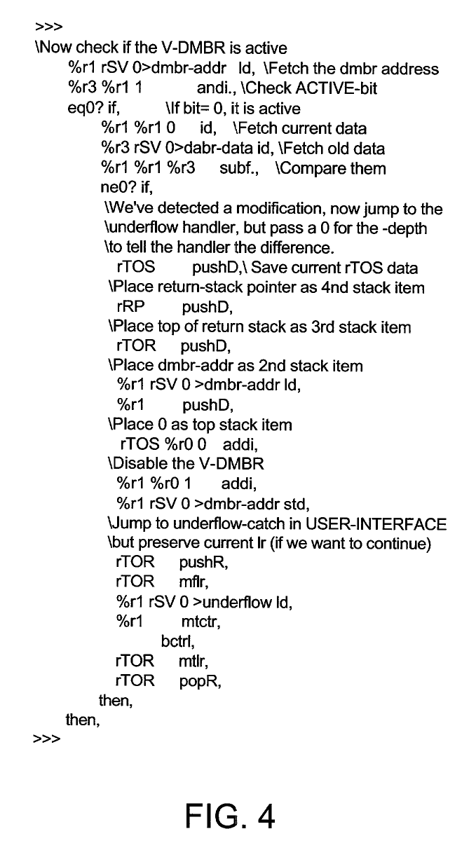

A compiler is a program that translates source code into object code. When doing so, the compiler looks at the entire source code, collects and reorganizes the instructions found therein. Thus, having the compiler behave as outlined in FIG. 4 is quite an easy task.

FIG. 3 is a flow chart of a process used by a compiler when implementing the invention. The process starts when the compiler is invoked (step 300). The compiler then inserts into the program instructions to identical variables V-DMBR and V-DMBR′. After the declaration of the variables, a command to have the value of V-DMBR copied into V-DMBR′ may be inserted into the program. Then each time a function call is encountered, the compiler may insert a command to compare the value of V-DMBR to the value of V-DMBR′ on the function call entry and exit. After each comparison command, the compiler may insert into the program a command to jump to “Software Handler” if there is a difference between the two values (steps 304-312).

FIG. 4 is an actual piece of code that may be used to implement the modifications of the compiler. It verifies that V-DMBR is on and then does the comparison where appropriate. V-DMBR is usually off until the data to be monitored is provided. Thus, although all programs compiled using the modified compiler will contain additional commands (i.e., the commands inserted by the compiler), they will not actually do the comparisons until the invention is activated. The invention is activated when the data to be monitored is set to V-DMBR. As mentioned above, the invention may be activated at any time during the execution of the program.

In any case, the code is written in Forth and is run on the target computer system. Forth is a high level programming language that operates in a similar fashion as an RPN (Reverse Polish Notation or postfix) calculator. It differs from typical programming languages such as C and Fortran in that a programmer need not recompile a program when adding a new functionality. For example, if a programmer needs to add a new command to a compiled program written in Forth, the programmer needs only define the new command and it will be available for use.

As mentioned above, after the program is compiled, it may be loaded on the computer system on which it is to run. To load a program on a computer system is to copy the program into the computer system's main memory where the program can be executed. When the program begins to execute, it will do so as usual until it gets to the point where the event-tracing-triggering command is encountered. At that point, V-DMBR will have the value of the data being monitored which will also be copied into V-DMBR′. On each function call encountered thereafter, the value of V-DMBR will be compared to V-DMBR′ on the function call entry and exit. Any difference between the two values is interpreted as a data corruption or modification. At that point Software Handler will be called.

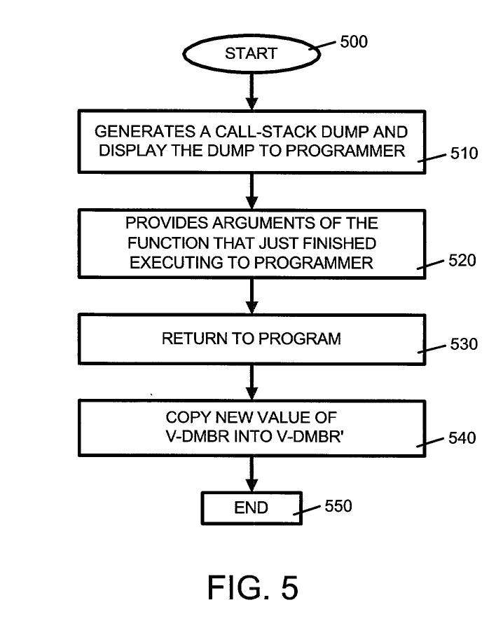

Software Handler is a software program that may interact with the programmer or at least provides the programmer with certain information. FIG. 5 is a flow chart of a process that may be used in implementing Software Handler. The process starts once a call to Software Handler is received (i.e., when the program jumps to Software Handler). Software Handler then generates a call-stack dump and communicates it to the programmer. Here, communicating the call-stack dump to the programmer encompasses displaying the call-stack dump on the screen of the computer system on which the program is being executed or writing it into a file for later analysis or for e-mailing it to the programmer. Any manner of presenting the call-stack dump to the programmer falls within the spirit and scope of the present invention.

Software Handler may also provide to the programmer the arguments of the function that was executing when the corruption occurred. After doing so, Software Handler may allow the program to continue to execute or may wait for further instructions from the programmer. This will allow the programmer to inspect the state of the program every time the variable is modified. In either case, Software Handler may have the new value of V-DMBR copied into V-DMBR′ for future comparison purposes in isolating data corruptions (see steps 500-550).

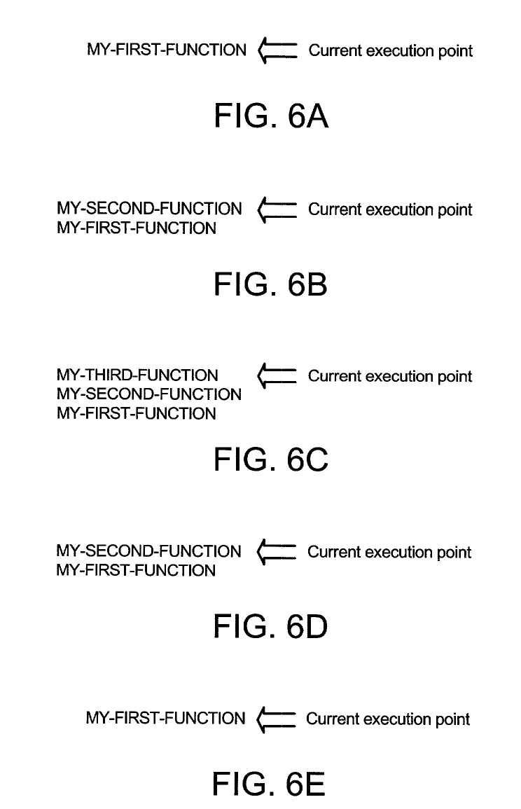

FIGS. 6A-6E illustrate a function call-stack. When first function MY-FIRST-FUNCTION is called, it is entered in the call-stack (or call chain). At that point, the call-stack is as shown in FIG. 6A. If function MY-SECOND-FUNCTION is called from MY-FIRST-FUNCTION, the call-stack is as shown in FIG. 6B. If function MY-THIRD-FUNCTION is called from MY-SECOND-FUNCTION, the call stack is as represented in FIG. 6C. When MY-THIRD-FUNCTION finishes to execute, it will exit and execution will return to the caller, MY-SECOND-FUNCTION (see FIG. 6D). Likewise, when MY-SECOND-FUNCTION finishes to execute, it will exit and execution will return to MY-FIRST-FUNCTION as shown in FIG. 6E. In our case, the Software Handler may be invoked after a function has finished executing. Consequently, each function call (including its arguments) may be stored into a buffer in case it is needed for a call-stack dump.

The description of the present invention has been presented for purposes of illustration and description, and is not intended to be exhaustive or limited to the invention in the form disclosed. Many modifications and variations will be apparent to those of ordinary skill in the art. For example, the invention may be activated by a software debugging tool long as the program was compiled using the modified compiler. In that case, the programmer may set the V-DMBR to the data to be monitored in the software debugging tool. The software debugging tool may in turn pass it to the executing program to activate the invention.

In addition, the programmer may insert the comparison commands into the source code of the program rather than having the compiler do so into the object code. To do so however, the programmer may have to insert a great number of lines of code. Furthermore, the programmer has to ascertain that the comparisons are done on each function call entry and exit as well as ensuring that call-stack dumps occur when a comparison yields a difference.

Thus, the embodiment was chosen and described in order to best explain the principles of the invention, the practical application, and to enable others of ordinary skill in the art to understand the invention for various embodiments with various modifications as are suited to the particular use contemplated.

What is claimed is:

1. A method of implementing a virtual data modification breakpoint register (V-DMBR) for isolating data modifications or corruptions comprising the steps of:
inserting a memory address to be monitored into a program; and
executing said program, said executing step including a copying of data stored at the monitored memory address into a second memory address, a comparing of the data stored at the monitored memory address with the data stored at the second memory address on each function call exit, and a generating of a call-stack dump if there is a difference between the data in the monitored memory address and the data in the second memory address.

2. The method of claim 1 further including the step of comparing the data stored at the monitored memory address with the data stored at the second memory address on each function call entry.

3. The method of claim 2 wherein commands for executing the steps of copying, comparing and generating are inserted into the program by a compiler at compile time.

4. The method of claim 3 wherein the compiler enters the commands for executing the steps of copying, comparing and generating into the program from where the memory address to be monitored is encountered in the program to the end of the program.

5. The method of claim 4 wherein the address to be monitored is identified by a variable.

6. A method of implementing a virtual data modification breakpoint register (V-DMBR) for isolating data modifications or corruptions comprising:
having a compiler insert into a program at compile time commands to copy data stored at a monitored memory address into a second memory address, to compare the data stored at the monitored memory address with the data stored at the second memory address on each function call exit and to generate a call-stack dump if there is a difference between the data in the monitored memory address and the data in the second memory address for isolating data modifications or corruptions.

7. The method of claim 6 wherein the data stored at the monitored memory address and the data stored at the second memory address are compared on each function call exit.

8. The method of claim 7 wherein the compiler inserts the commands into the program when directed to do so.

9. The method of claim 8 wherein the compiler begins to insert the commands in the program when an instruction to monitor an address is encountered.

10. A computer program product on a computer readable medium for implementing a virtual data modification breakpoint register (V-DMBR) for isolating data modifications or corruptions comprising:
code means for inserting a memory address to be monitored into a program; and
code means for executing said program, said executing code means including a copying of data stored at the monitored memory address into a second memory address, a comparing of the data stored at the monitored memory address with the data stored at the second memory address on each function call exit, and a generating of a call-stack dump if there is a difference between the data in the monitored memory address and the data in the second memory address.

11. The computer program product of claim 10 further including code means for comparing the data stored at the monitored memory address with the data stored at the second memory address on each function call entry.

12. The computer program product of claim 11 wherein the code means for executing the steps of copying, comparing and generating are inserted into the program by a compiler at compile time.

13. The computer program product of claim 12 wherein the compiler inserts the code means for copying, comparing and generating into the program from where the memory address to be monitored is encountered in the program to the end of the program.

14. The computer program product of claim 13 wherein the address to be monitored is identified by a variable.

15. A computer program product on a computer readable medium for implementing a virtual data modification breakpoint register (V-DMBR) for isolating data modifications or corruptions comprising:
code means for having a compiler insert into a program at compile time commands to copy data stored at a monitored memory address into a second memory address, to compare the data stored at the monitored memory address with the data stored at the second memory address on each function call exit and to generate a call-stack dump if there is a difference between the data in the monitored memory address and the data in the second memory address for isolating data modifications or corruptions.

16. The computer program product of claim 15 wherein the data stored at the monitored memory address and the data stored at the second memory address are compared on each function call exit.

17. The computer program product of claim 16 wherein the compiler inserts the commands into the program when directed to do so.

18. The computer program product of claim 17 wherein the compiler begins to insert the commands in the program when an instruction to monitor an address is encountered.

19. A computer system for implementing a virtual data modification breakpoint register (V-DMBR) for isolating data modifications or corruptions comprising:
at least a storage system for storing code data; and
at least one processor for processing the code data to insert a memory address to be monitored into a program and to execute the program to copy data stored at the monitored memory address into a second memory address, to compare the data stored at the monitored memory address with the data stored at the second memory address on each function call exit, and to generate a call-stack dump if there is a difference between the data in the monitored memory address and the data in the second memory address.

20. The computer system of claim 19 wherein the data stored at the monitored memory address and the data stored at the second memory address are compared on each function call entry.

21. The computer system of claim 20 wherein commands for copying, comparing and generating are inserted into the program by a compiler at compile time.

22. The computer system of claim 21 wherein the commands to copy, compare and generate are inserted into the program from where the memory address to be monitored is encountered in the program to the end of the program.

23. The computer system of claim 22 wherein the address to be monitored is identified by a variable.

24. A computer system for implementing a virtual data modification breakpoint register (V-DMBR) for isolating data modifications or corruptions comprising:
at least a storage device for storing code data; and
at least a processor for processing the code data to have a compiler insert into a program at compile time commands to copy data stored at a monitored memory address into a second memory address, to compare the data stored at the monitored memory address with the data stored at the second memory address on each function call exit and to generate a call-stack dump if there is a difference between the data in the monitored memory address and the data in the second memory address for isolating data modifications corruptions.

25. The computer system of claim 24 wherein the data stored at the monitored memory address and the data stored at the second memory address are compared on each function call exit.

26. The computer system of claim 25 wherein the compiler inserts the commands into the program when directed to do so.

27. The computer system of claim 26 wherein the compiler begins to insert the commands in the program when an instruction to monitor an address is encountered.
